(19) United States
(12) Patent Application Publication
(10) Pub. No.: US 2022/0148039 A1
(43) Pub. Date: May 12, 2022

(54) INTERMITTENTLY CONNECTED ADVERTISEMENT SYSTEM AND METHOD

(71) Applicant: MARGO NETWORKS PVT. LTD., Mumbai (IN)

(72) Inventors: Rohit Paranjpe, Mumbai (IN); Ripunjay Bararia, Mumbai (IN)

(73) Assignee: MARGO NETWORKS PVT. LTD., Mumbai (IN)

(21) Appl. No.: 17/513,722

(22) Filed: Oct. 28, 2021

(30) Foreign Application Priority Data
Nov. 11, 2020 (IN) 202021049249

(51) Int. Cl. G06Q 30/02

(52) U.S. Cl. CPC G06Q 30/0267

(57) ABSTRACT

An intermittently connected/hybrid advertisement (“ad”) network system and method uses a combination of localized Edge Computers/Ad servers installed within the Wi-Fi network or the Local area network of the user for data streamed over the network. The system and method enables delivering measurable Ads from an existing or independent Ad network with a targeting model for services accessed while connected to the Edge computers/localized Ad servers, as well as service data downloaded by the user on a user device. The intermittently connected Ad network system and method may utilize a software development kit (SDK) which is integrated by Digital services to utilize the full functionality of the Ad network.

### PRIORITY CLAIMS/RELATED CASES

This application claims priority under 35 USC 119 to Indian Patent Application Serial No. 202021049249 filed Nov. 11, 2020 and entitled “Intermittently Connected Advertisement System and Method”, the entirety of which is incorporated herein by reference.

### FIELD

The disclosure relates generally to a system for generating and displaying advertisements and in particular to an advertisement system for devices that are intermittently connected to a digital data network.

### BACKGROUND

Currently, digital services (Websites, Apps, etc.) can only monetize when a user (and the user device on which the Digital service is being accessed by the user) has seamless connectivity to the Internet. Without seamless connectivity, delivering ads to the user fails or is not possible. However, consumers access content offline as well—either by downloading data on their devices or accessing services/Apps that work without Internet connectivity (games, etc.). In developing countries, certain gaming Apps witness close to 50% of service consumption offline and that's a huge revenue loss for these businesses. The Ad industry also suffers substantial revenue losses due to failed Ad delivery attributable to patchy or unstable Internet connections or loss of internet connectivity during an impression being delivered (especially in case of video ads).

In addition to this, companies worldwide are setting up disconnected/intermittently connected digital consumption platforms (Local Wi-Fi based systems in aircrafts, buses, trains, remote areas, etc.). These platforms today can only display pre-provisioned Ad campaigns that are operated like traditional offline media which are based on duration or number of impressions. However, they are unable to offer critical Ad network functionalities like user targeting, click-throughs, dynamic campaigns, automated verified campaign measurement, etc. which makes it less attractive for advertisers. The typical process of display advertising is shown in FIG. 1.

A problem with current online ad networks is that advertisers are able to reach only those users who are connected to the internet and, in countries like India, still 50% of the population doesn't have access to the internet. Furthermore, even if the ad network is in a country with a large percentage of the population having internet access, patchy internet coverage causes the Ad industry to lose a lot of revenue caused by ad delivery failure as a result of the patchy internet coverage.

There are also significant problems with offline ad networks and system. For example, most offline ads lack real-time tracking options so that the impression of an offline ad campaign takes time to build. Furthermore, with current offline ad systems, it is difficult to accurately target the Target Audience of an ad which might lead to a lesser ROI.

One current proposed solution to the above problems has been ad caching in which, while the user downloads content to their device, the system pushes a few ads along with it so as if the user consumes the content offline at a later point of time, the publisher can still show some ads to the user. This proposed solution has limitations and problems. For example, there is a possibility that the ad can become irrelevant if the user consumes the downloaded content, say, post one week from the day of download of the ad and the content. Also, this provides no solution for ads with clicks and landing pages if the user is offline. Furthermore, the ad is being pushed to the user's device at the cost of user's data and device storage. Finally, the acceptance and credibility of the ad performance data is low.

Another solution involves dynamic offline ads in which some ads get downloaded onto the user's device at the time of download of content. However, after a specific time period, say 3-4 days, if the user device has Internet connectivity, the ads in the user's device get updated so that, when the user consumes the content offline next time he/she will get a more relevant/fresher ad. This solution has the same limitations and problems as ad caching.

Another solution is digital signage that is kept at public places like metros, stations, restaurants as a way to show digital ads to a target audience even if they are not connected to the internet. This can allow advertisers to reach out to a larger set of audiences based on the location of the Digital Signage. However, it is difficult to accurately target the Target audience of an ad which might lead to a lesser ROI and the number of ads that can be shown is limited. Furthermore, the updating of ads is manual and time consuming and it is difficult to measure the user engagement or ROI of those Ads.

There are also digital signage with an internet of things (IoT)/LTE in which the digital signage is connected to a central cloud system via LTE so that it is possible to schedule/reschedule which ad is shown at which place and time at each digital signage in the connected system through an intelligent central Content Management System. This system has the same problems and limitations as the digital signage system above.

Thus, it is desirable to provide an intermittently connected/hybrid ad system and method that overcomes the limitations and technical problems of the above known systems and it is to this end that the disclosure is directed.

### BRIEF DESCRIPTION OF THE DRAWINGS

FIG. 1 illustrates a typical display advertising method;

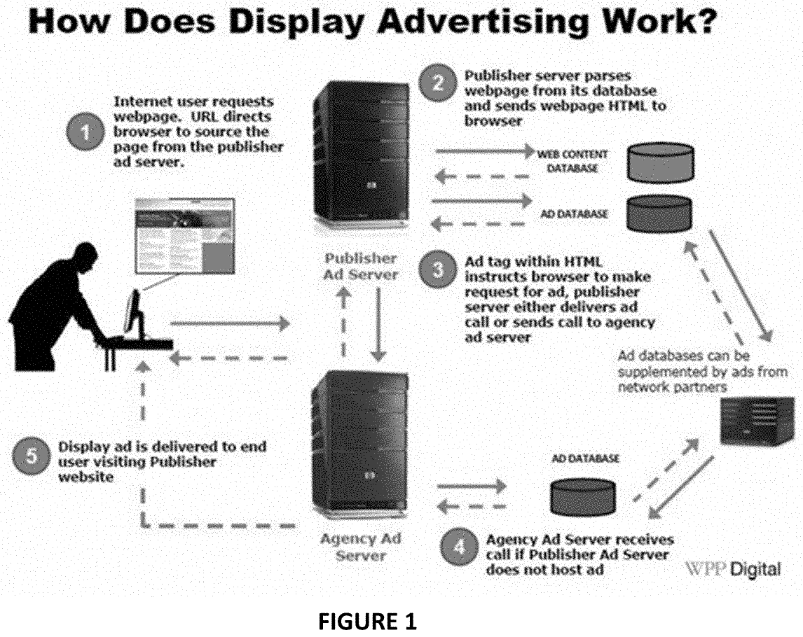

FIG. 2 is an example of an implementation of a content delivery network that may include an intermittently connected/hybrid advertisement system;

FIG. 3 illustrates more details of the intermittently connected/hybrid advertisement system implemented using an SDK on a computing device, an existing ad platform, one or more edge servers of the content delivery network and the data center;

FIG. 4 illustrates an intermittently connected/hybrid advertisement method;

FIG. 5 illustrates a data flow diagram of the intermittently connected/hybrid advertisement method; and

FIG. 6 illustrates a partial completion video payment process of the intermittently connected/hybrid advertisement system.

### DETAILED DESCRIPTION OF ONE OR MORE EMBODIMENTS

The disclosure is particularly applicable to a content delivery system (that has a WiFi connection for each computing device within range of a point of interest) that implements an intermittently connected/hybrid advertisement delivery system and method and it is in this context that the disclosure will be described. It will be appreciated, however, that the intermittently connected/hybrid ad system has greater utility since it can be implemented as a standalone system or with other systems in which it is desirable to provide offline advertisements and it can be implemented using other architectures and processes that are within the scope of the disclosure.

The content delivery system (or any other system that implements the intermittently connected/hybrid advertisement system) may provide a digital service (such as a search engine, a map, a game, a retail website, etc.) and those digital service(s) are able to serve Ads using a local Ad server installed within a Wi-Fi network even without the user device or the Ad server having access to internet connectivity thus allowing the owner/operator of the digital service to monetize their digital service. Furthermore, digital services will be able to serve Ads using an Ad network on disconnected/intermittently connected platforms installed in aircrafts, buses, trains, remote areas, etc. In addition, digital services will be able to serve Ads, even in downloaded content or games that are accessed offline (or other such offline use cases).

Thus, Digital services will be able to offer and Advertisers will be able to benefit from Ad network functionalities like user targeting, click-through functionality, dynamic campaigns and automated verified campaign measurement for Ads displayed in the various offline environments (user device and/or local ad server having no internet access and/or disconnected/intermittently connected systems and platforms. The intermittently connected Ad network enables advertisers to display Ads to its target users connected to a local edge server of a CDN in one embodiment. In the intermittently connected Ad Network, the Ads will be delivered from the local Ad server (inside the Edge server) to the users connected to the local Wi-Fi network of the Edge server. Here, the user device and the Edge server may or may not have internet connectivity. In this embodiment, the ad serving will pass from the Ad dashboard to the Central Ad Backend to all the Edge servers in the ecosystem based on the Ad targeting and the count of burned Ads/leads generated are captured and sent back from the Edge server to the Central Ad Backend.

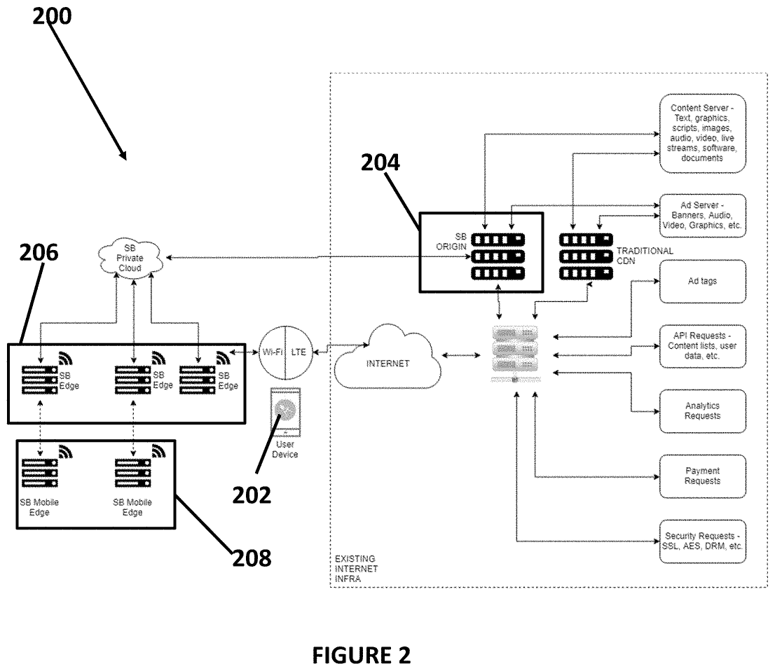

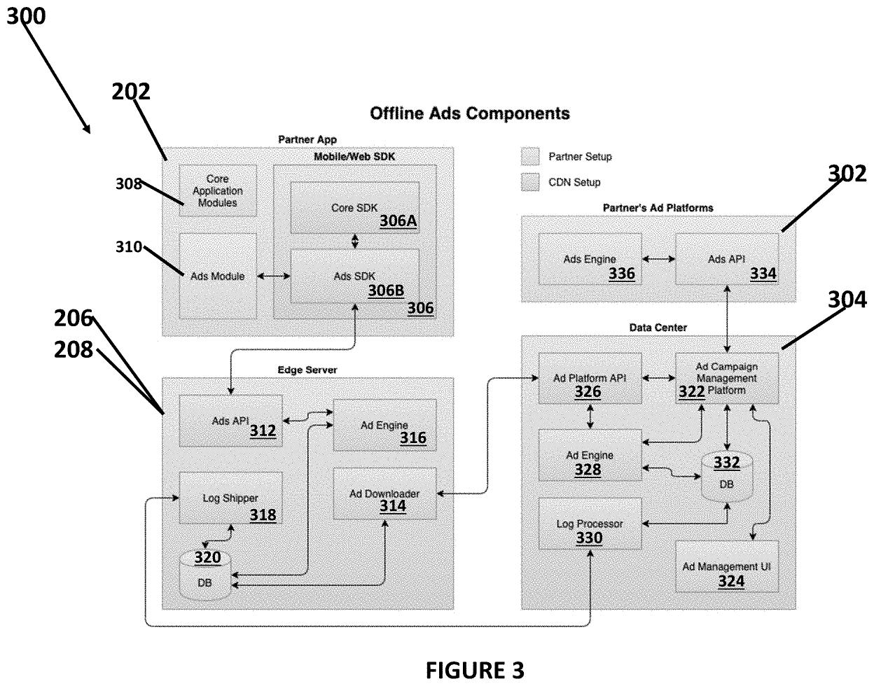

FIG. 2 is an example of an implementation of a content delivery network 200 that may include an intermittently connected/hybrid advertisement system. The system 200 may further comprise one or more SugarBox pieces of hardware 204-208 that may be connected to the cloud infrastructure at an internet data center and may also be coupled to each computing device 202 of a plurality of computing devices over Wide Local Area Network (WLAN) or a local Wi-Fi network that provides an additional communications path for each application request. Each Edge computer may be implemented as one or more server computers that are also equipped with a dedicated last mile over Wi-Fi or LAN at each CDN Edge. The CDN may include at least one CDN origin server 204, one or more mid-servers (not shown) and then one or more edge servers 206, 208 at the edge of the CDN. The mid-servers are between the origin server 204 and the one or more edge servers 206, 208. The payment system may be integrated into different elements of the CDN 200 such as the data center that houses the original server 204, the computing device 202, the edge server 206, 208 and a cloud payment platform as shown in FIG. 3 and described below in more detail.

As shown in FIG. 2, the CDN 200 may be connected to the existing internet infrastructure. However, with the attached dedicated last mile over Wi-Fi, the data from the CDN 200 is delivered using a last mile which is outside the purview of the existing internet infrastructure (LAN) thereby freeing up bandwidth on the existing internet infrastructure, especially on the last mile provided by Internet Service Providers/Telecom operators and reducing the load of the existing internet infrastructure last mile with an increase in the number of users accessing or the consumption per user.

The CDN 200 enables a user that doesn't have access to the internet using any of the existing connectivity options (Internet Service Provider or Telecom operator) to experience whole or part of any Digital Service. Furthermore, the offline ad system allows that same user to receive ads even when offline such that the provider of the digital service can still monetize the digital service even while the computing device, ad server, etc. are offline (not connected to the Internet.) The CDN 200 can continue to operate even when the connectivity of a CDN Edge server to the cloud Infrastructure is unavailable as the last mile can expose the data cached on the CDN Edge to the Service, thereby allowing access to the Service in an area without reliable and sustained connectivity (transport, remote locations, etc.) The CDN Edge 206, 208 is always one hop away from the user (as it is available to the user over a Local Area Network) than a traditional CDN Edge, thereby providing a faster data delivery and facilitating better user experience.

The CDN 200 uses a dedicated last mile, whereas the last mile in the existing internet infrastructure is a shared last mile for the CDN and all the other services running on the internet, thereby providing a faster data delivery and facilitating better user experience. The CDN 200 operates on a last mile that operates on an unlicensed bandwidth, thereby making scalability of the last mile virtually unlimited, thereby enabling the Service to provide a guarantee to consumers on the availability, reliability and bandwidth availability while using the Service.

Each CDN Edge 206, 208 may be placed at Places of interest (Buses, Trains, Aircrafts, Malls, Commercial Centres, Airports, Cafes, Restaurants, Bars, Hotels, Educational Institutes, Hospitals, Clinics, Residential Complexes, Corporate Parks, Public Parks, Theme Parks, Public Places, etc.), which provides a service to make the experience contextual to the user based on the proximity of the user to a place of interest, without using the location of the device.

In more detail, the novel CDN system 200 may have one or more Origin & Mid Servers 204 which reside inside an Internet Data Center. These servers operate similar to a traditional CDN. The system 200 may also have one or more Static Edge(s) 206 which is connected to the Origin 204 using physical high speed connectivity (P2P/MPLS) and has an attached Wi-Fi or LAN setup exposed to the user and one or more Mobile Edge(s) 208 which from a hardware and software stack standpoint is the same as the SugarBox Static Edge, but instead of having physical connectivity to the CDN 200, it is connected wirelessly using one of the two routes: 1) using MPLS/cellular data connectivity over a telecom network (may be intermittent and may not be high speed); or 2) using Wi-Fi and the corresponding physical connectivity from an Edge 206, 208 (Is always intermittent when the Mobile Edge comes in the network of a Static Edge and is high speed).

A digital service requires access to the following 6 elements to function: API Requests/HTTP Requests; Security Requests—DRM/AES/SSL; Analytics Requests; Content Requests—Content/Downloadable Objects/Web Objects; Ad Requests; and Payment Requests. Generally, Analytics, Payments and Security requests are served directly by the Service Provider through their own/third party servers. All other requests are fronted by a CDN as shown in FIG. 2. In this system, the offline advertisement system also operates to provide a technical solution to permit offline advertisements in the CDN 200 or any other system in which it is desirable to be able to provide and monetize advertisements even with no or limited connectivity such that online advertisement serving and monetization transactions would fail.

In one example, the novel CDN system 200 may be implemented in a particular configuration of hardware and software. The Origin & Mid 204 may include compute servers, storage servers and networking equipment and the Static & Mobile Edge 206, 208 may include compute+storage Server, networking equipment and Wi-Fi Equipment. Each computing device 202 may be a smartphone type device that executes apps (such as an Apple iPhone or Android operating system device and the like) that has a processor and memory that may store instructions that may be executed by the processor. The Origin & Mid 204 and each edge 206, 208 may also include content serving software, DNS, DHCP, logging & monitoring software and databases.

FIG. 3 illustrates more details of the offline advertisement system 300 implemented using an SDK on a computing device 202, an existing ad platform 302, one or more edge servers 206, 208 of the content delivery network and the data center 304. Thus, in the embodiment shown in FIG. 3, the intermittently connected/hybrid ad system 300 may be implemented using resources on the computing device 202, resources on the edge server(s) 206, 208, resource in the Ad partner cloud 302 and resources in a data center 304 that are interconnected as shown in FIG. 3. The solution 400 makes use of APIs provided by the ad partner(s) as explained in detail below. It is noted that the disclosed intermittently connected/hybrid advertisement system may also be implemented in different ways and with different resources that are all within the scope of the disclosure.

Each computing device 202 of each user may have a partner application executing on the computing device 202 that provides the digital service and serves ads to the user while using the digital service. The application may further have an SDK 306 that may be implemented as a plurality of instructions executed by a processor of the computing device so that the processor is configured to perform the processes of the SDK that are now described. The application executing of the computing device also may have a core application modules 308 and an ads module 310. The SDK 306 may further comprise the core SDK 306A and an Ads SDK 306B that communicates with the ad module 310.

In more detail, the Ads SDK 306B is a client side component for use inside of partner applications as shown in FIG. 3. It can be used as a plugin/addon with the Mobile SDK. The SDK may have a library that will provide an API to be utilized by partner applications 310, as and when required. The SDK 306B works with Ads API 312 available at the Edge Servers 206, 208 to communicate and fetch ads relevant to the user, for partner the app to render. This can also be used for generating any relevant events for analytics. Ads SDK 306B can be used across a variety of use cases—be it Media Ads, Banner Ads, etc. The partner will configure the Ad SDKs 306B and a bunch of parameters on Application bootup, and be ready for use by the partner app. This SDK will be supporting VPAID, VAST, or any other required standards.

Each edger server 206, 208 (that each has a WiFi connection for user computing devices in the vicinity of the particular edge server) may have the Ad API 312, an Ad downloader 314, an Ad engine 316, a log shipper 318 and a database (DB) 320 that are connected to each other as well as the computing device 202 and cloud infrastructure 304 as shown in FIG. 3. The Ad Downloader 314 is the software that will communicate with the Ad Platform API 322 available at the Data Center 304, to check and fetch the ads that are assigned to each Edge Server as described below in more detail. The Ad Downloader 314 can then maintain the data like a copy of the Ad Platform at the Edge Server in the local DB 320 which will be done periodically, depending on the connectivity, to check and fetch for any updates to ad campaigns or new ad campaigns.

The ad engine 316 at each Edge Server 206, 208 will function in a similar way to the Ad Engine at the Data Center. Its job would be to serve the right ads to the relevant users. This will be used by the Ads API 312 to provide the availability and ads itself to the user's device 202. The Ads API 312 may be the component that will be used by the clients (Ads SDK 306B in Mobile SDKs 306). The Ad API 312 may serve the ads and details to the client when requested and may work with Ad Engine 316 to get the availability of the ads and serve those ads to the client. As the Ads API 312 serves ads, and when ads are being streamed on the player executed by the computing device 20, the Ads API 312 generates stats/logs to record the impressions and user interactions. The log shipper 318 is responsible for sending the logs back to the Data Center 304 when connection to the Data Center 304 is available. As shown in FIG. 3, the edge server 206, 208 may be connected to the Ads SDK 306B and the data center 304 components.

The data center 304 may further comprise an Ad campaign management platform 322, an Ad management UI 324, an Ad platform API 326, an Ad Engine 328 and a log processor 330 and a local database (DB) 332 that are interconnected as shown in FIG. 3 and connected to the platform 302 and the edge servers 206, 208. The Ad campaign management platform 322 is a well known component and a central and critical component of the whole platform that maintains all the campaigns and acts as a repository for maintaining all the active/past campaigns and is connected to the platform 302 to receive the campaign data. The Ad management UI 324 is connected to the management platform 322 generates a user interface/user experience (UI/UX) shown to partners and internal users where each can go out and bid for Ads and Ad slots offered within the Intermittently connected Ad Ecosystem. The users can create campaigns and choose certain configurable parameters such as preferred User Personas, Target Audiences, etc. Campaign limits can be set on this very same dashboard and progress of the campaigns, success/failure rates, potential leads, will all be displayed in this well organised Dashboard to the Ad partner 302. This UI will also provide reporting interfaces for partners and internal users to understand the ad performance.

The Ad platform API 326 is connected to the Ad engine 316 of the edge server 206, 208, the Ad engine 328 and the management platform 322 and is an API layer that will be utilized by the components at other systems to interact with the central Ad Platform. For example, the API may be used by the Ad Management UI to manage the ad campaigns and also used by the components at the Edge Servers to understand the availability of assigned ads and any updates to ad campaigns. The Ad engine 328 is connected to the Ad platform API 326, the management platform 322 and the local DB 322 and may be responsible for deciding on assigning the relevant ads to edge servers 206, 208 depending on the edge server location and the parameters and filters set for the ad campaigns. Thus, the system is assigning ads to provide hyperlocal personalization to the user based on the edge server being accessed by the user. More specifically, the ads may be assigned to each edge server based on multiple factors including, for example, demographics of users at a POI of the edge server, an app/Service usage patterns at a POI of the edge server and/or user context at a POI (e.g., whether it is a transactional POI like a Mall or a leisure POI like a Restaurant or an emergency POI like a hospital.)

The log processor 330 may be connected to the log shipper 318 of each edge server 206, 208 and the local DB 332 and is responsible for syncing back the ad impressions and stats and populating logs/DB records locally based on the logs shipped from all the edge/mid servers 206, 208. This log shipping and processing is part of the mechanism of the offline ad network that permits offline ads to be served and monetized since the log shipper captures the ads server while offline at each edge server 206, 208 and then sends them back to the log processor 330.

Each advertisement partner may have its ad platform/system 302 that has an Ads API 334 that connected to the management platform 322 of the data center and an ad engine 336 connected to the Ads API 332 so that an advertiser creates/manages their ads at one platform and the ad network takes care of pushing it to multiple publishers, hence providing advertisers one interface to manage ads. Thus, the advertiser does not have to upload the same inventory multiple time and enable a seamless integration of the flow of inventory to offline ad system.

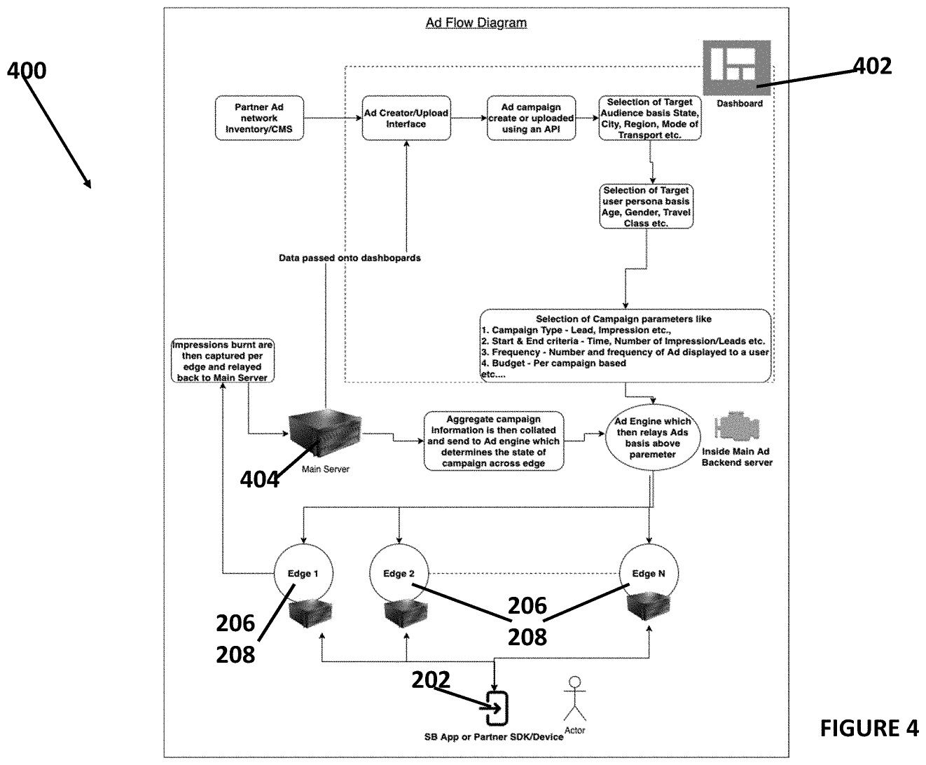

FIG. 4 illustrates an intermittently connected/hybrid advertisement method 400 in which the offline ad network can integrate with a third party ad platform as shown in FIG. 3 to sync the ad campaigns to this system. And then with help of the Ad Management UI, partners or internal users can manage the ad campaigns as and when required. The method may use a campaign dashboard 402. The Campaign Dashboard enables any ad clients to create a campaign, or to sync campaigns from App partner/other ad network servers, upload the RO & define the parameters of the campaign like budget, targeting, CPM (cost per thousand impressions), etc. through the Dashboard. Here the campaign dashboard enables creation of campaign basis state, city, area, edge and a user persona. It can also be a combination of parameters for each campaign. The campaign also will take input of the Ad slot and a bid price for that. The Ad dashboard 402 will also show the performance of all the Ad campaigns in the Ad ecosystem.

The Ad Backend 404 (shown as a main server in this example) takes the input of the dashboard regarding the campaign requirements and allocates the campaign to different Edges 206, 208 in the ecosystem that satisfy the targeting parameters of the campaign as described above. In addition, the Ad Backend will collect the reports on ad campaign performance across various edges. The Ad Backend will have the intelligence to allocate or reallocate slots across Edge servers—based campaign performance and ensure that the Ad is delivered to user personas defined in the campaign.

Each edge server 206, 208, whenever there is connectivity, may download a list of campaigns and targets it needs to achieve during a particular time period along with other details of the campaign like CPM, target audience etc. The Ad engine 316 within the Edge server 206, 208 will talk to Ad SDK 306B integrated inside the applications and fetch the required Ad assets to the User device based on the Ad request by the Ad SDK 306B. In addition, each edge server will report (using the log shipper 318) to the Central Ad Backend 302, 304 regarding the status of each campaign whenever the Edge server 206, 208 gets connectivity to the Central Ad Backend 302, 304.

The computing device 202 of each user of the system provides the digital service to the user using partner application executed by the processor of the computing device and then serves the selected ads to the user (in both connected mode and in offline ad mode) to facilitate monetization of the digital service even during time when the computing device and edge server do not have connectivity to the backend ad systems 302, 304. When a user is connected to the edge server 206, 208 and accessing a partner app/digital service, the Ad SDK 306B inside the app will talk with the ad engine 316 inside the Edge server 206, 208 to request for details of all ads qualifying for an ad slot, and based on the response from the edge server 206, 208, the Ad SDK 306B will decide the final ad to be rendered to the User. The Ad SDK 306B, when connected wirelessly to the edge server 206, 208 may also fetch required Ad assets to the user device 202 from the Edge Server 206, 208 to be able to then select and serve those ads. Once an ad is burned (shown to the user), the details of the ad (which may also include the details of the lead generated) will be stored at both the Edge server 206, 208 (the log shipper 318 and DB 320) and user device 202 and will be sent to the Central ad backend 302, 304 whenever the edge server 206, 208 gets internet connectivity. This is another aspect of the offline ad network that allows the offline ad serving and monetization of the digital service provided by the intermittently connected/hybrid ad network. For more detailed targeting, some specific user details will be stored in the user device 202 so that whenever a user device 202 gets connected to an Edge 206, 208, the Ad SDK can use this user data from the user device & decide which Ad to show to the user.

The intermittently connected/hybrid ad system and method may be used for a variety of different advertisements. For example, the ads may include Banner Ads, Video Ads, Form Ads, Banner Ads with call to action (CTA)+Landing page, Video Ads with CTA+Landing page and/or Interstitial Ads. For Ads with a CTA, the subsequent landing pages will be cached on the Edge server 206, 208 so as to be ready to be fetched to the user device.

When the user is completely offline (no connection between the user or edge server and the ad network), the intermittently connected/hybrid ad system and method can deliver ads during pure offline consumption by the user of the downloaded app (on the computing device as shown in FIG. 2) and its contents. When a user downloads data from a local edge server 206, 208, the edge server 206, 208 with the help of Ad SDK 306B can push Ads along with the data so that even if the user consumes this app/content offline (no Internet & not connected to a local edge server 206, 208), Ads can still be shown to the user. The Ad SDK manages the delivery of Ads to the user during pure offline consumption and details of the burned ads will be stored in the application data stores. Whenever the device gets internet connectivity, these details will be sent back to the central ad backend 302, 304 so that the applicant/content provider can monetize their digital service through the display of the ads. If the user gets connected to a local edge server 206, 208, then the details will be passed on to the local edge 206, 208 which will then pass the details to the central ad backend 302, 304 based on availability of internet.

Each of the elements of the intermittently connected/hybrid ad system shown in FIG. 3 are configured in the partner app and whenever an ad slot is available in a partner app connected to the Edge server 206, 208, the Ad SDK 306B may determine the best ad to be shown on that ad slot—from all the qualifying ads available at the Edge server, based on different parameters like Ad bid, user location & other user targeting parameters.

The intermittently connected/hybrid ad system may also provide a mechanism/process to create a new ad campaign. For example, an advertiser can create an ad campaign through the ad dashboard and set the user targeting, & campaign bid (CPX). The various user targeting parameters for a campaign may include, but are not limited to: Location, Point of Sale (where the edge server is installed), Time period, User age group, User Gender, User Interest, User Behaviour, etc. Based on the type of the ad, user targeting and campaign bid, the ad dashboard can show an estimate of maximum potential reach of the ad campaign which will be the sum of the potential reach at each edge server which got qualified for the campaign based on the targeting.

As mentioned above, the intermittently connected/hybrid ad system and method may have a process to allocate ads to each edge server 206, 208. Based on the broad level requirement gathered from the client, the Ad management system 322/Central Ad Backend 302, 304 may identify the potential Edge servers that satisfy the criteria set by the Advertiser and push those ads to the qualifying edges 206,208. The Edge servers 206, 208 will start pushing the ad to the users, and all the Edges 206, 208 in the system will keep updating the Central Ad Backend 302, 304 regarding the progress of the campaigns assigned to them on ASAP basis whenever there is connectivity.

The Central Ad backend 302, 304 may keep pushing the campaign to the Edges 206, 208 until the time period of the campaign is over; or the required impressions are achieved in the ad system. If any of the above conditions are satisfied, the Central Ad Engine 336 may stop running the campaign. During each synchronization between the Central Ad Engine 336 and each edge server 206, 208 for each ad campaign, the Central Ad backend 302, 304 may inform the Edge 206, 208 regarding the pending target for each campaign (e.g.: pending impressions to be burned) and/or the maximum number of impressions which the edge can burn based on the expected achievable impressions at each edge which will be predicted based on past data. The value of the multiplier will be the function of the pending impressions/target to be achieved.

For example, if two edge servers (edge sever 1 & 2) are assigned a target of burning 500 ad impressions each (total 1000) on a daily basis. If one of the edge servers (edge server 1) goes offline for a longer period and couldn't connect to the Central Ad backend, the edge server 1 won't be able to pass the data of the achieved impressions at that edge server or to get new ad targets for itself from the Central Ad backend. In this context of no information coming from Central Ad backend, to ensure that the overall target for Ad (1000 impressions) is achieved, instead of 500, the edge server 1 (that couldn't connect to Central Ad backend) will increase its target by a multiplier say 1.2. So instead of 500 impressions, it will have to burn 500*1.2=600 impressions. This will ensure that even if edge server 2 fails to achieve its target (say achieving 400 instead of 500), edge server 1 will try to compensate by burning 600 impressions instead of 500 and hence achieving the total Ad target (1000 impressions). Also, since edge server 2 is the only server which is accessible right now, the central Ad backend will allocate the total target of 1000 impressions (multiplier of 2 in this case) to edge server 2 assuming edge server 1 is not available any more. However, as soon as the edge server 1 comes online at a later point in time, the data of burned impressions will be passed to the Central backend from edge server 1.

If an Edge 206, 208 goes offline for a longer period of time, say, for more than 2-3 hours, the edge 206, 208 will continue to burn the ads. However, in that case, the priority will be given to those ads whose pending volume will be highest and then the ad with 2nd highest pending ad volume and so on in Phase I. This will continue till the Edge 206, 208 gets connectivity & response from the Central Ad backend 302, 304.

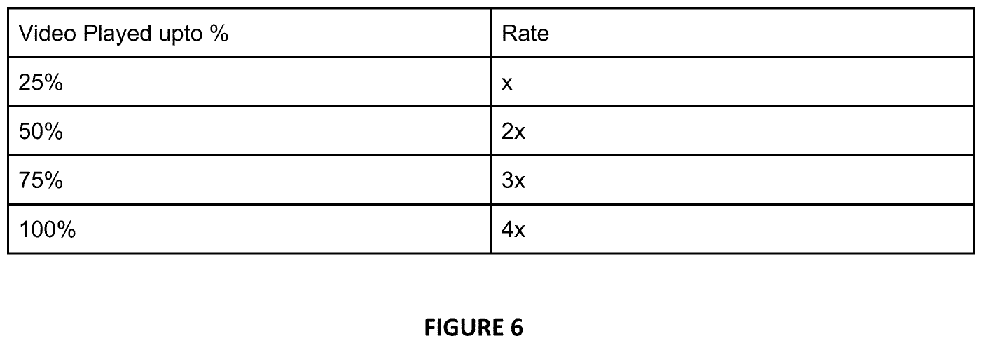

The intermittently connected/hybrid ad system and method may include a process to account for ads. For example, for non-skippable video ads, the system may calculate a compensation rate for partially completed videos. FIG. 6 illustrates an example of an implementation of an algorithm used for this calculation in which a percentage of video that the user has seen results in the clients being billed based on the quartile % completion as shown in FIG. 6. Another example, a banner ad will be accounted as an impression if 100% of the banner image has been shown to the user or for form ads, the pricing will be based on the final lead delivery and the client will be charged based on the number of leads generated.

The intermittently connected/hybrid ad system and method may also have a process for campaign reporting. In particular, whenever an ad is accounted for, the Edge server 206, 208 may store the details of the ad/campaign along with the user details. Whenever an edge/user device gets connectivity to the Central Ad backend, the details of all the ads/impressions burned/leads generated along with the details of the user & engagement will be sent to the Central Ad backend.

The intermittently connected/hybrid ad system and method may also have a process for campaign monitoring. The central Ad backend 302, 304 may collect the performance info of all the running campaigns from all the edge servers on a regular basis and collates the same at the central ad backend. The ad engine 336 at the ad backend can then display the information on the Ad dashboard for the consumption of clients and the campaign team. This dashboard permits a client to monitor the progress of all the campaigns relevant to them and/or a campaign team can monitor the performance of all campaigns in the system (live/expired). Through the monitoring dashboard clients can monitor the performance of the ad at an edge server level or based on the targeting parameters set for that ad campaign.

The intermittently connected/hybrid ad system and method may also have a process for the transfer of ad logs. In particular, for static Servers 206 of the CDN, the ad logs are transferred to the backend through ISP connectivity. For the mobile servers 208, all the ad related data transfer between the central ad backend & mobile edges should happen via LTE Dongle.

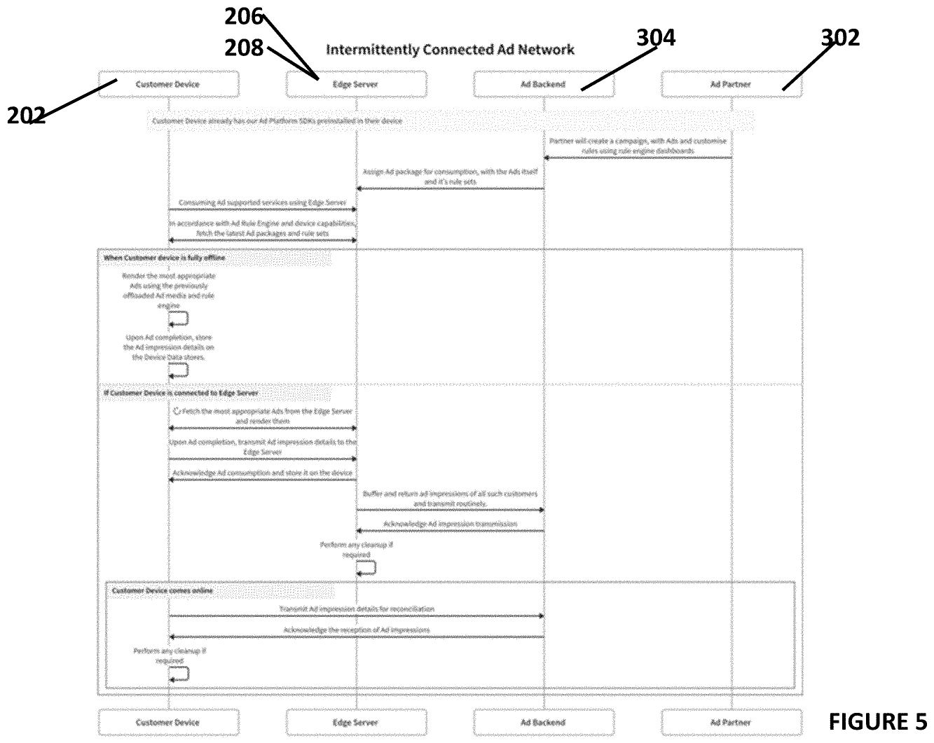

FIG. 5 illustrates a data flow diagram of the intermittently connected/hybrid advertisement method. In the method, advertising Partners use customisable dashboards wherein, they create smartly targeted campaigns, along with campaign assets and targeting algorithms as discussed above. The advertising Partners may choose the Ad formats that they render—Interstitial, Banner Ads or Video Ads, etc. The Ad targeting uses AI/ML algorithms along with a simplified rule engine and capability to define campaign parameters such as total impression counts, campaign duration, etc. The AI/ML algorithms may take into consideration various factors which evidence the past behaviour of the users/users connecting an edge server, including but not limited to: 1. Last active day, 2. Preferred content language/genre, 3. Performance/conversions of previously shown ads & ad types, and/or 4. Last connected edge server/location. The past data is processed to understand the various behaviour patterns and from that predict the probability of a future action like the probability of a user responding a particular type of ad based on his/her past impressions/CTR data.

In the method, ads may be automatically assigned to the local Ad Servers) (in edge servers 206, 208) installed across regions, localities, target areas, etc. The Ad SDKs 306B in each computing device 202 have intelligent models built-in, which are able to pre-cache ads onto the user device, or request them from the local Ad server over Wi-Fi when possible. The SDK Ad Engine makes sure that Ads are rendered to users according to the predefined rules, even when the device is fully offline.

In the method, reconciliation and attribution of delivered impressions occurs as soon as the Ad Server or the user's device gets access to Internet connectivity. The method may have a robust fingerprinting+reconciliation mechanism based on user's advertisement identifier built at the backend to ensure zero data loss. The Ad SDKs 312 in each computing device 202 may have its own smaller AI/ML algorithms, that shows ads to the user based on the past behaviour of the user, running on the user device, using platform provided APIs such as MLKit for Android and iOS, which determine the best Ads to render to the user among the ones pre-cached on the device. The Ad SDKs 312 also keep updating their internal Ad Engine Models as and when they connect to the local Ad server or get access to internet connectivity. For example, the Ad engine models in the SDKs may be updated when the device is connected to the local edge server or a data center servers.

The method can also implement any Click-Through functionalities of the Campaign building dashboards, with full customization and get cached along with the Ad assets on the local Ad server or the user device.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method for providing a digital service in an offline environment, comprising:
providing a location having intermittent connection to a digital network for delivering advertisements using an intermittently connected/hybrid advertisement computer system, the location having an edge server of the intermittently connected/hybrid advertisement computer system that provides a wireless connection at the location to a computing device of a user, the computing device executing a digital services application with an advertisement software development kit (SDK);
storing one or more advertisements for an ad campaign remote from the digital network for delivering advertisements;
rendering, while the user is consuming the digital services of the application and the computing device is disconnected from the digital network for delivering advertisements, one or more advertisements on the computing device;
storing an ad impression for each advertisement rendered while the computing device is disconnected from the internet or the digital network for delivering advertisements; and
communicating, when the computing device is connected to the internet or digital network for delivering advertisements, the stored ad impressions to the digital network for delivering advertisements so that the digital services are monetized even when the computing device is disconnected from the digital network for delivering advertisements.

2. The method of claim 1, wherein storing the one more advertisements further comprises storing the one or more advertisements on the computing device and wherein rendering the one or more advertisements further comprising rendering the one or more advertisements stored on the computer device.

3. The method of claim 1, wherein storing the one more advertisements further comprises storing the one or more advertisements on the edge server to which the computing device is wirelessly connected and wherein rendering the one or more advertisements further comprising rendering the one or more advertisements stored on the edge server.

4. The method of claim 3 further comprising sending the ad impression for each advertisement rendered on the computing device to the edge server over the wireless connection and sending, by the edge server, the ad impressions for each advertisement rendered on the computing device to the digital network for delivering advertisements.

5. The method of claim 1 further comprising determining a value for an ad impression for a partially completed piece of video content.

6. The method of claim 1 further comprising generating the ad impression when the advertisement is rendered on the computing device.

7. The method of claim 6, wherein the ad impression further comprises a lead generated when the advertisement is rendered on the computing device.

8. The method of claim 3 further comprising downloading, from the digital network for delivering advertisements to the edge server, the one or more advertisements.

9. The method of claim 8, wherein the one or more downloaded advertisements are assigned to each edge server based on an advertisement campaign requirement of the digital network for delivering advertisements.

10. The method of claim 1, wherein the location of the edge server is one of a disconnected and intermittently connected platform.

11. The method of claim 1, wherein the consumed digital service is a downloaded piece of content.

12. The method of claim 11, wherein the downloaded piece of content is a game.

13. The method of claim 8 further comprising fetching, by the computing device, the one or more advertisements from the edge server.

14. The method of claim 1, wherein each advertisement is one of a banner advertisement, a video advertisement, a form advertisement, a banner advertisement with a call to action and a landing page, a video advertisement with a call to action and a landing page and an interstitial advertisement.

15. The method of claim 9, wherein the advertisement campaign requirement for each edge server further comprises an advertisement target being a number of pending advertisement divided by a total number of edge servers in the intermittently connected/hybrid advertisement computer system multiplied by a multiplier.

16. An offline system, comprising:
a computing device of a user that has a processor that executes a plurality of instructions of a software development kit (SDK) to configure the processor to interact with a digital service consumed by the computing device;
an edge server, wirelessly connected to the computing device, the edge server part of an offline advertisement system that facilitates the rendering of advertisements on the computing device from a system for delivering advertisements;
the offline advertisement system having cloud infrastructure that is connected to the edge server wherein the edge server delivers one or more advertisements to the SDK;
the processor of the computing device further configured to
store one or more advertisements for an ad campaign remote from the system for delivering advertisements;
render, while the user is consuming the digital services of the application and the computing device is disconnected from the digital network for delivering advertisements, one or more advertisements on the computing device;
store an ad impression for each advertisement rendered while the computing device is disconnected from the digital network for delivering advertisements; and
communicate, when the computing device is connected to the digital network for delivering advertisements, the stored ad impressions to the digital network for delivering advertisements so that the digital services are monetized even when the computing device is disconnected from the digital network for delivering advertisements.

17. The system of claim 16, wherein the processor of the computing device is further configured to store the one more advertisements on the computing device and render the one or more advertisements stored on the computer device.

18. The system of claim 16, wherein the edge server stores the one or more advertisements and wherein the processor of the computing device is further configured to render the one or more advertisements stored on the edge server.

19. The system of claim 18, wherein the processor of the computing device is further configured to send the ad impression for each advertisement rendered on the computing device to the edge server over the wireless connection and wherein the edge server sends the ad impressions for each advertisement rendered on the computing device to the system for delivering advertisements.

20. The system of claim 16, wherein the system for delivering advertisements determines a value for an ad impression for a partially completed piece of video content.

21. The system of claim 16, wherein the processor of the computing device is further configured to generate the ad impression when the advertisement is rendered on the computing device.

22. The system of claim 21, wherein the ad impression further comprises a lead generated when the advertisement is rendered on the computing device.

23. The system of claim 18, wherein the edge server downloads the one or more advertisements from the system for delivering advertisements.

24. The system of claim 16, wherein the consumed digital service is a downloaded piece of content.

25. The system of claim 24, wherein the downloaded piece of content is a game.

26. The system of claim 23, wherein the processor of the computing device is further configured to fetch the one or more advertisements from the edge server.

27. The system of claim 16, wherein each advertisement is one of a banner advertisement, a video advertisement, a form advertisement, a banner advertisement with a call to action and a landing page, a video advertisement with a call to action and a landing page and an interstitial advertisement.

28. The system of claim 16, wherein the edge server provides the wireless connectivity to the computing device at a location and wherein the location is one of an intermittently connected platform.
